(19) United States
(12) Patent Application Publication
(10) Pub. No.: US 2022/0084084 A1
(43) Pub. Date: Mar. 17, 2022

(54) COGNITIVE ASSESSMENT OF DIGITAL CONTENT

(71) Applicant: International Business Machines Corporation, Armonk, NY (US)

(72) Inventors: Lisa Seacat DeLuca, Baltimore, MD (US); Chandler Maskal, Melrose, MA (US)

(21) Appl. No.: 17/018,426

(22) Filed: Sep. 11, 2020

(51) Int. Cl. G06Q 30/02; G06N 20/00

(52) U.S. Cl. CPC G06Q 30/0283; G06N 20/00

(57) ABSTRACT

A processor may analyze a set of available digital content. The set of available digital content includes one or more available digital content. Each of the available digital content includes one or more assets. The processor may assign, based on asset type, a value type to each asset in the set of available digital content. The processor may couple a value amount to each value type based on one or more locations in a set of locations. Each location in the set of locations has a value amount associated with the value type. The processor may apply a machine learning model to the set of available digital content. The machine learning model utilizes feedback regarding the value amount and value type tailored to each location. The processor may determine an aggregate value amount for a selected set of assets of the set of available digital content.

### BACKGROUND

The present disclosure relates generally to the field of digital value assessment, and more specifically to providing improved value assessment for digital content by utilizing cognitive systems.

Digital retail permits a large number and variety of goods to be sold to consumers in many locations. When the value of goods may vary based on location, assessing the value of the goods may be challenging. One type of value associated with the goods may be levies on the goods, where the levies are associated with a particular location.

### SUMMARY

Embodiments of the present disclosure include a method, computer program product, and system for providing improved value assessment for digital content by utilizing cognitive systems.

In some embodiments, a processor may analyze a set of available digital content. In some embodiments, the set of available digital content may include one or more available digital content. Each of the available digital content may include one or more assets. The processor may assign, based on asset type, a value type to each asset in the set of available digital content. The processor may couple a value amount to each value type based on one or more locations in a set of locations. Each location in the set of locations may have a value amount associated with the value type. The processor may apply a machine learning model to the set of available digital content. The machine learning model utilizes feedback regarding the value amount and value type tailored to each location. The processor may determine an aggregate value amount for a selected set of assets of the set of available digital content.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an exemplary system for assigning a value to available digital content, in accordance with aspects of the present disclosure.

FIG. 2 is a flowchart of an exemplary method for assigning a value to available digital content, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of digital value assessment, and more specifically to providing improved value assessment for digital content by utilizing cognitive systems. While the present disclosure is not necessarily limited to such applications, various aspects of the disclosure may be appreciated through a discussion of various examples using this context.

In some embodiments, a method for assigning a value to available digital content is provided. In some embodiments, a processor may analyze a set of available digital content. The set of available digital content may include one or more available digital content. The available digital content may include one or more assets. In some embodiments, the set of available digital content may include any assets that are capable of being sold through electronic means, including through any platforms available through the Internet or computing devices networked with each other. In some embodiments, the one or more assets may be digital assets that may be available to a user (e.g., customer, client, etc.) for downloading from the Internet.

As an example, the set of available digital content may include digital content and assets that are available for sale on a marketplace that connects manufacturers (such as OEMs) with owners and operators. In some embodiments, the digital content may include digital twin templates which may be digital resources that represent assets that are repeatable to any physical asset or a specific instance of a physical asset. For example, a digital twin may be created as a digital representation of a physical asset, equipment, building, or vehicle.

In some embodiments, the set of available digital content may include the resources that make-up the digital twin templates. Exemplary assets may include, but are not limited to: bills of materials, parts lists, user manuals, engineering manuals, fault codes, 2D/3D CAD files, augment reality or virtual reality models, maintenance manuals, maintenance plans, operating models, remote procedures for future technicians, stocking strategies, forecast models, building information models, service manuals, manuals, parts, manufacture date or age, modernization/refurbishment date, manufacturing warranty notifications, warranty claims, insurance claims, insurer insurance policy, maintenance plans, maintenance history, inspection history, specifications (including specification to 3D print a part), 3D models, engineering change history, fault codes, scheduled maintenance plans, operating manuals, sensor data, operating history, predictive operating model (using artificial intelligence and other techniques) owner, change in ownership, etc.

In some embodiments, the processor may assign, based on asset type, a value type to each asset in the set of available digital content. In some embodiment, each asset may be associated with an asset type, and the asset type may be associated with a value type. In some embodiments, the asset type may be a label or categorization for the asset that relates the asset to a value type. An asset type may be assigned based on the file type or file extension (e.g., pdf, j son, xls, csv, cad, model, bim). In another embodiment, the asset type may be determined based on natural language processing of the content of the digital content (e.g., keywords such as “operating manual” are present in the description within the file). In some embodiments, the value type may be a label or categorization for the asset that relates to a value amount. In some embodiments, the value type may be a rate of taxation applied to the sale price of an asset. In some embodiments, the asset type may be a category which the asset falls into that describes the rate of taxation applied to the sales price of the asset.

For example, a bill of materials asset may be associated with a Category A asset type (e.g., a digital download, digital good, digital book, book, software, data, etc.), a maintenance plan may be associated with a Category B asset type, and an operating history may be associated with a Category C asset type. The Category A asset type may be associated with a 10% value type (e.g., rate of taxation), and the Category B asset type may be associated with a 20% value type. The Category C asset type may be associated with a 0% value type.

In some embodiments, the asset type or the value type may be specific to one or more locations in a set of locations. For example, in the United States location, user manuals may be associated with a digital download asset type, whereas in the Taiwan location, user manuals may be associated with a book asset type. Additionally, in the Unites States, digital download asset types may be associated with a 10% tax value type, whereas in Taiwan the digital download asset type may be associated with a 3% tax value type.

In some embodiments, the processor may couple a value amount to the value type based on one or more locations in a set of locations. In some embodiments, each location in the set of locations may respectively have a value amount associated with the value type. In some embodiments, the locations may be countries in the world, cities or states in the countries, or locations within the cities and/or states. In some embodiments, the locations may be jurisdictions where the value amount associated with the value type and/or the asset type may be different (e.g., the jurisdictions are governed by different tax laws).

For example, a set of assets (e.g., including an engineering manual, a 3D CAD file, a virtual reality model, and a maintenance plan) may be purchased by customers in a set of locations including five locations: New York State, California, Taiwan, Canada, and an economic development zone in Jersey City, N.J., where each location is governed by different tax laws. Each asset may be associated with an asset type and a value type for each location. For example, the engineering manual may belong to the book asset type in New York, California, and the economic development zone Jersey City, N.J. The value type for the engineering manual associated with the book asset type may vary in New York, California, and the Jersey City economic development zone. For example, value type may be a “standard sales tax” value type in New York, a “standard sales tax” value type in California, and a “low sales tax” value type in the Jersey City economic development zone.

In some embodiments, the value amount may be coupled to the value type based on the location. Following the example above, for an engineering manual with a $10 purchase price may have a 0.8 dollar value amount for the New York location based on the standard sales tax in New York State, a 0.6 dollar value amount for the California location based on the standard sales tax category in California, and a 0.23 dollar value amount for the Jersey City economic development zone based on the low sales tax category in the economic development zone.

Continuing the example, the engineering manual may belong to a digital download asset type in Canada and Taiwan. The engineering manual with the digital download asset type may be associated with a “four percent value added tax” value type in Canada and a “four percent value added tax” value type in Taiwan. For an engineering manual with a $10 purchase price, the value amount coupled to the value type in Canada may be 0.4 dollars, and the value amount coupled to the value type in Taiwan may be 0.4 dollars. Thus, for a particular value type (e.g., standard sales tax, low sales tax, zero percent value added tax, four percent value added tax) there is an associated value amount, for each asset, for each location. In some embodiments, the value amount for each location for a particular value type may be different. In some embodiments, the value amount for each location for a particular value type may not be different.

In some embodiments, the processor may apply a machine learning model to the set of available digital content. In some embodiments, the machine learning model may assign the asset type or value type to one or more assets. In some embodiments, the machine learning model may couple the value amount to each value type based on one or more locations in a set of locations. In some embodiments, the machine learning model may utilize or be updated to include feedback regarding the value amount and value type tailored to each location. In some embodiments, the machine learning model may utilize or be updated to include feedback regarding asset type.

For example, value type “standard value added tax” may be associated with asset type Category A, and for location Canada, the standard value added tax may be associated with value amount 0.20 for a particular asset. The machine learning model may be updated with feedback indicating that value type “zero value added tax” should instead be associated with asset type Category A in Canada. The feedback may have been obtained from an audit by tax auditors that resulted in a correction of the association of a value type with the Category A asset type based on identification of an inadvertent error in the previously associated value type or based on a revision to tax laws, or their interpretation, in the location. As another example, the machine learning model may be updated with feedback indicating that value amount 0.40 for a particular asset should be associated with value type “standard value added tax” in Canada.

In some embodiments, the feedback with which the machine learning model is updated may be feedback regarding the asset type for an asset, and consequently, the value type and value amount for the asset may be updated as well. In some embodiments, the machine learning model may be any machine learning model configured to assign asset type or value type to an asset. In some embodiments, the machine learning model may be any machine learning model configured to couple, by the processor, a value amount to each value type based on one or more locations. In some embodiments, the machine learning model may be any machine learning model configured to be updated with, or utilize, feedback regarding the value amount, value type, or asset type associated with an asset tailored to a location.

In some embodiments, the feedback regarding the value amount and the value type tailored to each location may include a validation as to the accuracy of both the value amount and the value type tailored to each location. For example, the value type or value amount for an asset may be assigned to an asset by a user. The machine learning model may utilize the feedback regarding value amount and value type to validate the accuracy of the previously assigned value type or value amount. The machine learning model may validate the accuracy by confirming the value type or value amount or by changing the value type or value amount.

In some embodiments, the processor may determine an aggregate value amount for a selected set of assets of the set of available digital content. In some embodiments, a processor may determine the aggregate value amount by utilizing, from the machine learning model, a mapping of the selected set of assets to form an aggregated asset. In some embodiments, the processor may generate the aggregate value amount for a selected location. For example, a user may select a set of assets including 200 user manuals, 100 parts lists, 50 operating models, 200 forecast models, and 400 CAD drawings. Based on the asset type and value type for each asset, and the location, a value amount for each asset may be determined.

Furthering the example, the value amount for each user manual may be $0.10, the value amount for each parts list may be $0.20, the value amount for each operating model may be $0.10, the value amount for each forecast model may be $0.15, and the value amount for each CAD drawing may be $0.01. The aggregate value amount may aggregate the value amount for the selected set of assets. Thus, the aggregate value amount may combine the value amount for the 200 user manuals, 100 parts lists, 50 operating models, 200 forecast models, and 400 CAD drawings to obtain an aggregate value amount of $79.

In some embodiments, the aggregate value amount may be determined based on the value type associated with a largest number of assets for selected asset types in the selected set of assets. For example, the selected set of assets may include 100 bills of materials assets, 200 parts lists assets, and 300 user manuals assets. The bills of materials assets, parts lists assets, and user manuals assets may be each associated with an asset type (e.g., category A, category B, and category C, respectively), value type (e.g., 1% tax, 4% tax, and 8% tax, respectively) and value amount (e.g., 0.04 (1% multiplied by the $4.00 sales price for each bills of material), 0.04 (4% multiplied by the $1.00 sales price for each parts list), and 0.16 (8% multiplied by the $2.00 sales price for each user manual, respectively). In this case, the value type associated with a largest number of assets is the value type associated with the user manual assets because there are 300 user manual assets and 300 is larger than the 200 parts list assets and 100 bills of material assets. To determine the aggregated value amount, the value type associated with the user manual assets, 8% tax, may be applied to the total sales price of all the assets (e.g., the sum of $4.00 multiplied by 100 for the bills of material assets, $1.00 multiplied by 200 for the parts list assets, and $2.00 multiplied by 300 for the user manual assets). The aggregate value may be determined to be 8% applied to the total sales price of all of the assets (e.g., $1,200), $96.

In some embodiments, the aggregate value amount may be determined based on a value type associated with a greatest value for selected asset types in the selected set of assets. For example, the selected set of assets may include three assets (e.g., bills of materials, parts lists, user manuals), each associated with a different asset type (e.g., digital content, paper content, manufacturing content, etc.), value type (e.g., 1% tax, 4% tax, and 8% tax), and a value amount (e.g., 0.04 (1% multiplied by the sales $4.00), 0.04 (4% multiplied by the $1.00 sales price), and 0.16 (8% multiplied by the $2.00 sales price). The value types (e.g., 1% tax, 4% tax, and 8% tax) for each asset may be compared to determine the value type associated with the greatest value. In this case 8% tax may be associated with the greatest value because compared to one percent and four percent, eight percent is a larger percent. The aggregate value amount may be determined to be 8% of the total sales price of the three assets ($4.00, $1.00, and $2.00), $0.56. As another example, the value type associated with the greatest value may be 1% tax because it is the percentage tax associated with an asset having the highest sales price (e.g., $4.00), and the aggregate value amount may be determined to be 1% of the sales price of the three assets, $0.07.

In some embodiments, the aggregate value amount may be augmented according to a ratio of selected assets in the selected set of assets. For example, the selected set of assets may include 100 user manuals assets, 200 parts lists assets, and 300 CAD drawings assets. The user manuals assets, parts lists assets, and CAD drawings assets may be each associated with an asset type (e.g., category A, category B, and category C, respectively) and value type (e.g., 1% tax, 4% tax, and 4% tax, respectively). A ratio of the assets, 5/6, are associated with the 4% tax value type. The assets associated with the 4% value type (e.g., parts lists and CAD drawings) may be bundled separately (e.g., grouped separately for purposes of determining an aggregate value amount) from the assets not associated with the 4% value type (e.g., the user manuals).

In some embodiments, assigning asset types or value types to each asset included in the set of available digital content may include assigning, automatically, the asset type or value type based on identification data associated with each of the assets included in the set of available digital content. In some embodiments, the identification data may be obtained from a file type of the asset uploaded to a marketplace (e.g., the asset may be a digital asset such as a CAD drawing that is uploaded to the marketplace as a drawing (.dwg) file), a description of the assets available to customers of the marketplace (e.g., a description identifying the asset as a CAD model), text in the file uploaded to the marketplace (e.g., the file is a bill of materials and the file of the bill of materials contains a header identifying the document as a bill of materials), other attributes of the asset, etc.

In some embodiment, the asset type and/or the value type may be assigned to each asset manually by a user. For example, a user may select an asset type of a set of asset types to associate with one or more assets or a value type of a set of value types to associate with one or more assets. In some embodiment, the asset type and/or the value type may be assigned to each asset automatically utilizing a machine learning model.

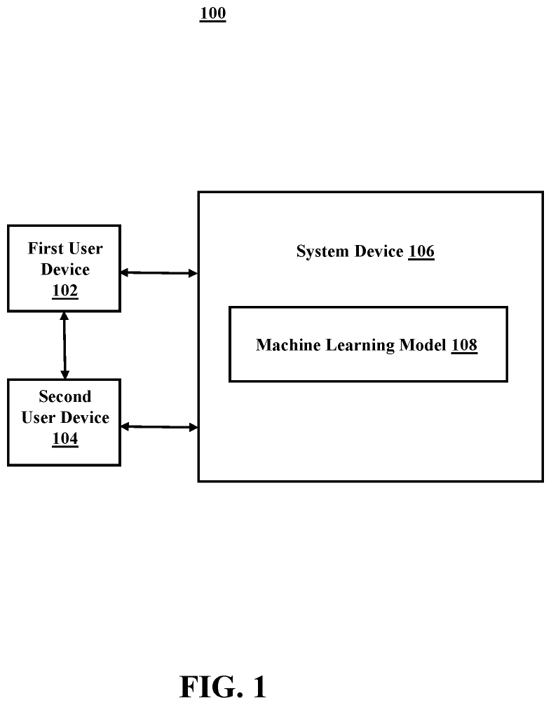

Referring now to FIG. 1, a block diagram of a network 100 for assigning a value to available digital content is illustrated. Network 100 includes a first user device 102, a second user device 104, and a system device 106 which are configured to be in communication with at least one of the other devices 102-106. In some embodiments, the first user device 102, the second user device 104, and the system device 106 may be any devices that contain a processor configured to perform one or more of the functions or steps described herein this disclosure. System device 106 includes a machine learning model 108.

In some embodiments, the first user device 102 conveys (e.g., uploads, stores, etc.) information regarding a set of available digital content to the system device 106. The information conveyed may include identification data or other information from which system device 106 may assign an asset type or a value type to one or more assets. The information conveyed may also include an assignment of an asset type or a value type by the first user (e.g., the user of the first user device 102 or a seller) to some or all of the assets in the set of available digital content.

In some embodiments, the system device 106 couples (e.g., links, assigns, etc.) a value amount to each value type associated with an asset type that is associated with an asset. The value amount may be an amount of tax from the sale of the asset. The amount of tax may be determined from rules regarding the amount of tax (e.g., tax percentages, tax percentages applied to a certain amount of the sales price, flat tax rates, etc.). In some embodiments, the rules may be stored in a repository/database 110 within the system device 106. The rules regarding the amount of tax are determined based on the value type associated with an asset. For example, the value type may describe, or be associated with, a tax percentage rate based on which a tax amount is calculated. The system device 106 couples a value amount to each value type based on one or more locations in a set of locations, where each location in the set of locations has a value amount associated with the value type.

In some embodiments, the system device 106 applies a machine learning model 108 to the set of available digital content. In some embodiments, the machine learning model 108 may be utilized by the system 106 to aid in the assigning of an asset type to an asset in the set of available digital content. In some embodiments, the machine learning model 108 may be utilized by the system 106 to aid in the assigning of a value type to an asset in the set of available digital content. In some embodiments, the machine learning model 108 may be utilized by the system 106 to aid in the coupling of a value amount to each value type based on one or more locations in a set of locations. In some embodiments, the machine learning model 108 may be utilized by the system 106 to aid in the changing of an asset type, value type, or value amount based on feedback regarding the value amount, value type, or asset type tailored to each location.

In some embodiments, when a second user (e.g., a customer) selects a set of assets for purchase from the system device 106, the selected set of assets is conveyed from the second user device 104 to the system device 106. The system device 106 determines an aggregate value amount for the selected set of assets of the set of available digital content. In some embodiments, the system device 106 identifies the location of the second user device 104 (e.g., from location services, IP addresses, etc.) and tailors the aggregate value amount based on the location. In some embodiments, the system device 106 and/or the second user device 104 may communicate with the first user device 102 to inform the first user of which assets were selected by the second user (e.g., to help the first user identify which digital content to focus on producing).

In some embodiments, either before or after the second user receives (e.g., purchases) the selected set of assets on the second user device 104, the machine learning model 108 will utilize feedback from the second user device 104 and update the asset types, value types, and/or value amounts associated with the received selected set of assets. For example, the system device 106 utilizing the machine learning model 108 may have assigned a first asset type, a first value type, and a first value amount based on the location of the first user device 102 that uploaded the digital content. Then, before or after the second user device 104 receives the selected set of assets, where the second user device 104 is in a second location, the machine learning model 108 may update the first asset type, the first value type, and the first value amount to a second asset type, a second value type, and a second value amount, or any combination of types thereof.

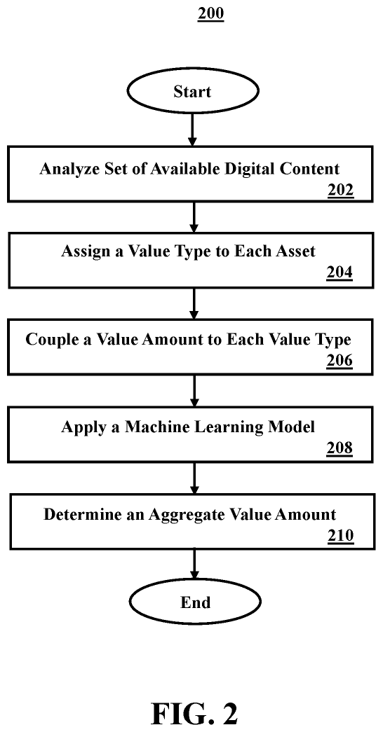

Referring now to FIG. 2, illustrated is a flowchart of an exemplary method 200 for assigning a value to available digital content, in accordance with embodiments of the present disclosure. In some embodiments, method 200 begins at operation 202. At operation 202, a processor analyzes a set of available digital content. In some embodiments, the set of available digital content includes one or more available digital content. In some embodiments, each of the available digital content includes one or more assets. In some embodiments, method 200 proceeds to operation 204, where a value type is assigned, based on asset type, to each asset in the set of available digital content. In some embodiments, method 200 proceeds to operation 206. At operation 206, a value amount is coupled to each value type based on one or more locations in a set of locations. In some embodiments, each location in the set of locations has a value amount associated with the value type. In some embodiments, method 200 proceeds to operation 208. At operation 208, a machine learning model is applied to the set of available digital content. In some embodiments, the machine learning model utilizes feedback regarding the value amount and value type tailored to each location. In some embodiments, method 200 proceeds to operation 210. At operation 210, an aggregate value amount is determined for a selected set of assets of the set of available digital content.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

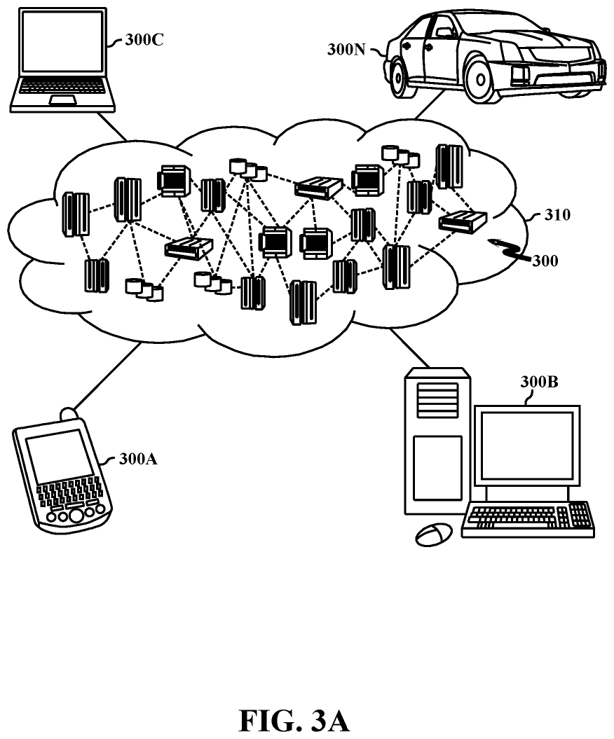

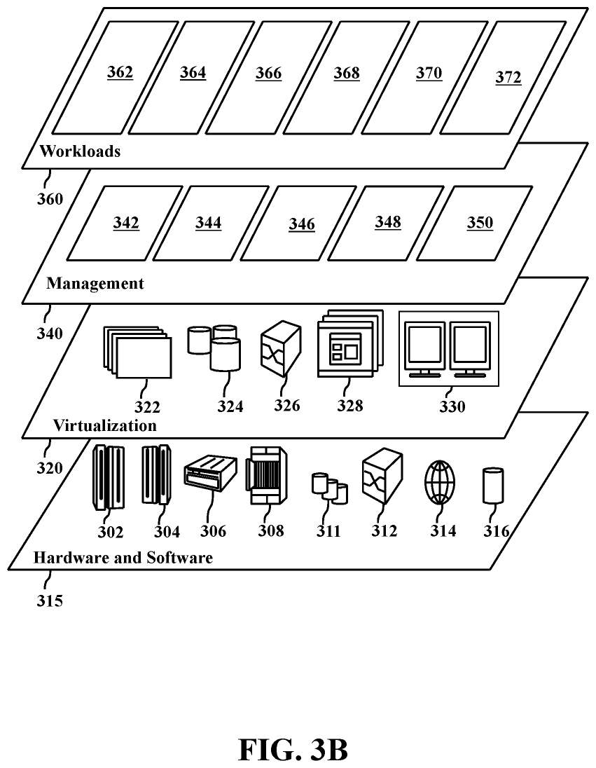

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and assigning a value to available digital content 372.

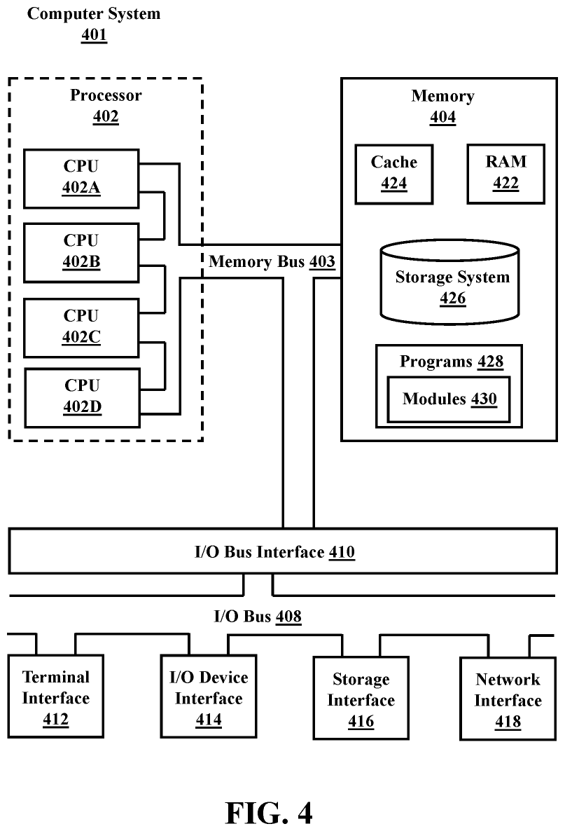

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method for assigning a value to available digital content, comprising:
analyzing, by a processor, a set of available digital content, wherein the set of available digital content includes one or more available digital content, and wherein each of the available digital content includes one or more assets;
assigning, based on asset type, a value type to each asset in the set of available digital content;
coupling a value amount to each value type based on one or more locations in a set of locations, wherein each location in the set of locations has a value amount associated with the value type;
applying a machine learning model to the set of available digital content, wherein the machine learning model utilizes feedback regarding the value amount and value type tailored to each location; and
determining an aggregate value amount for a selected set of assets of the set of available digital content.

2. The method of claim 1, wherein the feedback regarding the value amount and the value type tailored to each location includes a validation as to the accuracy of both the value amount and the value type tailored to each location.

3. The method of claim 1, wherein determining the aggregate value amount comprises:
utilizing, from the machine learning model, a mapping of the selected set of assets to form an aggregated asset; and
generating the aggregate value amount for a selected location.

4. The method of claim 1, wherein assigning the value type to each asset included in the set of available digital content comprises:
assigning, automatically, the value type based on identification data associated with each of the assets included in the set of available digital content.

5. The method of claim 1, wherein the aggregate value amount is augmented according to a ratio of selected assets in the selected set of assets.

6. The method of claim 1, wherein the aggregate value amount is determined based on the value type associated with a largest number of assets for selected asset types in the selected set of assets.

7. The method of claim 1, wherein the aggregate value amount is determined based on the value type associated with a greatest value for selected asset types in the selected set of assets.

8. A system comprising:
a memory; and
a processor in communication with the memory, the processor being configured to perform operations comprising:
analyzing, by a processor, a set of available digital content, wherein the set of available digital content includes one or more available digital content, and wherein each of the available digital content includes one or more assets;
assigning, based on asset type, a value type to each asset in the set of available digital content;
coupling a value amount to each value type based on one or more locations in a set of locations, wherein each location in the set of locations has a value amount associated with the value type;
applying a machine learning model to the set of available digital content, wherein the machine learning model utilizes feedback regarding the value amount and value type tailored to each location; and
determining an aggregate value amount for a selected set of assets of the set of available digital content.

9. The system of claim 8, wherein the feedback regarding the value amount and the value type tailored to each location includes a validation as to the accuracy of both the value amount and the value type tailored to each location.

10. The system of claim 8, wherein determining the aggregate value amount comprises:
utilizing, from the machine learning model, a mapping of the selected set of assets to form an aggregated asset; and
generating the aggregate value amount for a selected location.

11. The system of claim 8, wherein assigning the value type to each asset included in the set of available digital content comprises:
assigning, automatically, the value type based on identification data associated with each of the assets included in the set of available digital content.

12. The system of claim 8, wherein the aggregate value amount is augmented according to a ratio of selected assets in the selected set of assets.

13. The system of claim 8, wherein the aggregate value amount is determined based on the value type associated with a largest number of assets for selected asset types in the selected set of assets.

14. The system of claim 8, wherein the aggregate value amount is determined based on the value type associated with a greatest value for selected asset types in the selected set of assets.

15. A computer program product comprising a computer readable storage medium having program instructions embodied therewith, the program instructions executable by a processor to cause the processor to perform operations, the operations comprising:
analyzing, by a processor, a set of available digital content, wherein the set of available digital content includes one or more available digital content, and wherein each of the available digital content includes one or more assets;
assigning, based on asset type, a value type to each asset in the set of available digital content;
coupling a value amount to each value type based on one or more locations in a set of locations, wherein each location in the set of locations has a value amount associated with the value type;
applying a machine learning model to the set of available digital content, wherein the machine learning model utilizes feedback regarding the value amount and value type tailored to each location; and
determining an aggregate value amount for a selected set of assets of the set of available digital content.

16. The computer program product of claim 15, wherein the feedback regarding the value amount and the value type tailored to each location includes a validation as to the accuracy of both the value amount and the value type tailored to each location.

17. The computer program product of claim 15, wherein determining the aggregate value amount comprises:
utilizing, from the machine learning model, a mapping of the selected set of assets to form an aggregated asset; and
generating the aggregate value amount for a selected location.

18. The computer program product of claim 15, wherein assigning the value type to each asset included in the set of available digital content comprises:
assigning, automatically, the value type based on identification data associated with each of the assets included in the set of available digital content.

19. The computer program product of claim 15, wherein the aggregate value amount is determined based on the value type associated with a largest number of assets for selected asset types in the selected set of assets.

20. The computer program product of claim 15, wherein the aggregate value amount is determined based on the value type associated with a greatest value for selected asset types in the selected set of assets.
